(19) United States
(12) Patent Application Publication
(10) Pub. No.: US 2005/0284339 A1
(43) Pub. Date: Dec. 29, 2005

(54) Durable building article and method of making same

(76) Inventors: Greg Brunton, Castlehill (AU); Ihor Hinczak, Liverpool (AU); Chongjun Jiang, Alta Loma, CA (US); Marcus Henry Kuizenga, Alta Loma, CA (US); Peter Pagones, Earlwood (AU); Brian Sloane, Old Toongabbie (AU); Huaijun Wang, Rancho Cucamonga, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/078,651

(22) Filed: Mar. 11, 2005

Related U.S. Application Data
(63) Continuation of application No. 10/873,723, filed on Jun. 21, 2004, now abandoned.
Application No. 10/873,723 is a continuation-in-part of application No. 10/117,401, filed on Apr. 3, 2002.
(60) Provisional application No. 60/281,195, filed on Apr. 3, 2001.
(60) Provisional application No. 60/480,304, filed on Jun. 20, 2003.

(51) Int. Cl. C04B 28/00

(52) U.S. Cl. 106/713; 264/333; 52/313

(57) ABSTRACT

A durable, nailable, lightweight and fire resistant fiber cement article that can be a cost-effective substitute for conventional building materials is provided. The fiber cement article can be profiled to resemble a roofing article such as a wood shake or slate. The fiber cement article incorporates a hydrophobe and a viscosity enhancing agent that are each selected to control the rate of hydration of the binder. The fiber cement article is durable, is walkable and nailable without cracking during installation and maintains walkablilty after exposure in service.

### RELATED APPLICATIONS

This application is a continuation of U.S. patent application Ser. No. 10/873,723, filed Jun. 21, 2004. This application is also a continuation-in-part of U.S. patent application Ser. No. 10/117,401, filed Apr. 3, 2002, which claims priority to U.S. Provisional Patent Application No. 60/281,195 filed Apr. 3, 2001, all of which are herein incorporated by reference in their entirety. This application also claims priority to U.S. Provisional Patent Application No. 60/480,304 filed Jun. 20, 2003, which is also hereby incorporated by reference in its entirety.

### BACKGROUND OF THE INVENTION

1. Field of the Invention

This invention in one embodiment relates to fiber cement articles, and in particular, relates to a light-weight, durable, and nailable fiber cement article that can be conveniently installed as a roofing tile.

2. Description of the Related Art

Natural roofing materials such as slate and wood shakes are two of the more prevalent forms of roofing articles currently used worldwide. However, there are disadvantages associated with each. Slate roofing materials are expensive to quarry, shape, and install. Wood shakes, typically made from insect-resistant cedar, are popular for their aesthetic appearances and easy installation, but the low availability of high quality cedar and new building codes restrictions are driving a need for replacement materials that have the appearance of wood shakes.

As a result, concrete roofing products, such as fiber cement roofing tiles, have been developed as a replacement for wood shakes and slate. However, the high density of traditional fiber cement roofing materials make them very difficult to nail. Therefore, they are typically manufactured with pre-drilled nail holes. However, a drawback of predrilled holes is that the roofing installer has very little flexibility if the predrilled holes do not line up with the anchoring points on roof sheathing, especially so called “skip-sheathing” where the sheathing boards are spaced in such a manner that they would not align with the predrilled holes. To address this drawback, roofing installers typically fill in the spaces of skip-sheathed roofs with additional sheathing boards, which can further add to the roof weight and extend installation time.

Currently available cement composite and concrete roof tiles also are susceptible to cracking and breakage when compressive and tensile forces are applied against the tile. These concrete and cement roofing materials, especially lightweight tiles, are by nature brittle and prone to cracks and breakage when walked on. Some cement composite roofing materials may have enough initial ductility to resist breakage during installation, but invariably embrittle with age and become unwalkable. To address this problem, many manufacturers currently recommend the use of walking pads, walking boards, or the application of polyurethane foam underneath the roofing material to help distribute the weight of persons who need to traverse the roof for maintenance purposes. However, these additional protections are inconvenient and costly to implement.

Moreover, conventional concrete or cement composite roofing tiles make installation of a covering over the hip or ridge areas of a roof especially problematic. Roofs are typically made with different pitches according to local building practices. In order to cover the hip or ridge areas, rigid concrete tiles must be formed with several different angle profiles and manufacturers must stock multiple profiles in order to accommodate a variety of roof styles. Other cement composite roofing tiles require careful time consuming positioning and nailing in order to ensure the hip and ridge areas were properly covered.

Roof coverings, especially slates, shakes or tiles, are typically installed in an overlapping fashion working from the bottom edge of the roofline towards the peak or ridge. If the bottom row of roof covering does not overlap anything, it will lie flush against the roof deck at an angle different than that the overlapping pieces above it. This is not only aesthetically unacceptable but also poor construction practice because the overlapping pieces would be unsupported the pieces in the first row and prone to breakage. To overcome this, traditional practice has been to for roofing installers to take a tile, slate or shake, cut it in half to form a cant strip or starter strip. A cant strip is placed underneath each bottom row piece so that the bottom row is oriented an angle to the roof deck that is approximately equal to the of the overlapping piece. While this practice is sound from an aesthetic and performance standpoint, it is wastes material and is time consuming.

In light of the foregoing, it is therefore desirable to provide a light-weight, medium to low-density fiber cement material that is nailable without cracking, maintains its initial ductility and walkability after exposure in service, maintains its flexural or tensile strength after freeze/thaw exposure, and performs well in wind-uplift tests. Moreover, it is also desirable to provide a light-weight, durable, nailable roofing article that resembles natural wood shake, slate, or other traditional roofing materials. Moreover it is desirable to provide fibercement roofing articles that may be used as hip or ridge coverings or as cant strips.

It is an object of the present invention to overcome or ameliorate at least one of the disadvantages of the prior art, or to provide a useful alternative.

### SUMMARY OF THE INVENTION

In one aspect, the preferred embodiments of the invention provide a formulation for manufacturing a cement composite roofing article. The formulation comprises a hydraulic binder, aggregate, a low density additive, fibers, a hydrophobe, wherein the components are selected to produce a cement composite roofing article having a Modulus of Rupture (MoR) to Modulus of Elasticity (MoE) ratio of about 1.2 MPa/Gpa or greater, a density of about 1.6 g/cm³ or less, and said roofing article is nailable and substantially resistant to stress induced cracking. In one embodiment, the formulation further comprises a viscosity enhancing agent. In another embodiment, the formulation further comprises fillers and pigments. Preferably, the fibers are selected from the group consisting of cellulose fibers, polypropylene fibers, polyester fibers, polyolefin fibers, nylon fibers, and combinations thereof. Preferably, the hydrophobe is selected from the group consisting of stearates, silicones, paraffin waxes, asphaltic, and combinations thereof.

In another aspect, the preferred embodiments of the present invention comprises a cement composite roofing article having a MoR/MoE ratio of about 1.2 MPa/Gpa or greater, a density of about 1.6 g/cm³ or less, and is nailable without developing stress induced cracking. In one embodiment, the roofing article is a roofing tile. In another embodiment, the roofing article is configured to resemble a wood shake tile or a slate tile. In yet another embodiment, the roofing tile has a thickness ranging between about 5/16 to ⅝ inch and an aspect ratio of about 35 to 1. In yet another embodiment, the roofing article further includes at least one reinforcement layer positioned in an area on the roofing article that is exposed to stress, such as an area adapted to receive a fastener. Preferably, the reinforcement layer is selected from the group consisting of a fiber mesh, fabric, film, and combinations thereof. The reinforcement layer can be embedded in the roofing article or attached to a lower surface of the roofing article.

In yet another aspect, the preferred embodiments of the present invention comprise a cement composite roofing article configured for covering the hip or ridge areas of a roof. The roofing article comprises a first portion comprising a nailable and substantially crack resistant cementitious material, a second portion comprising a nailable and substantially crack resistant cementitious material. Preferably, the first and second portions are hingedly connected to each other by a connecting member such that at least one of the portions is pivotable about a central axis defined by the connecting member. In one embodiment, the connecting member comprises a flexible reinforcement material such as a fiber mesh. Preferably, the connecting member is attached to a lower surface of each of the two portions. In one embodiment, the angle between the two portions of the roofing article can be adjusted between about 30 to 180 degrees.

### BRIEF DESCRIPTION OF THE DRAWINGS

FIGS. 1A and 1B are schematic illustrations of different embodiments of a cement composite roofing article of the present invention;

FIG. 2 provides a flow chart for a method of producing a cement composite roofing article of a preferred embodiment of the present invention;

FIG. 3 illustrates comparative rates of water uptake of cement composite roofing articles made in accordance with several different formulations, including the formulation of a preferred embodiment of the present invention;

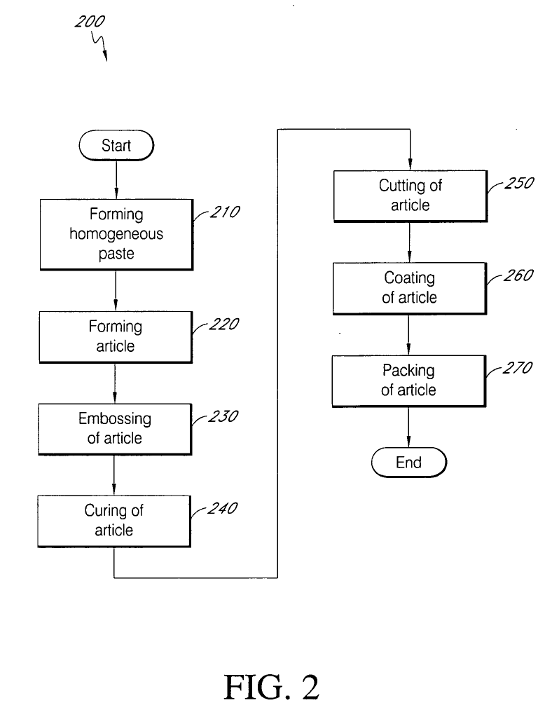

FIG. 4 illustrates comparative freeze/thaw performance of a cement composite roofing article of a preferred embodiment as compared to conventional high density slate and shake roofing tiles;

FIG. 5 is a schematic illustration of the underside of a cement composite roofing article of a preferred embodiment of the present invention; and

FIG. 6 illustrates a cross sectional view of a cement composite roofing article of a preferred embodiment configured for covering the hip or ridge areas of a roof.

### DETAILED DESCRIPTION OF THE PREFERRED EMBODIMENTS

Reference will now be made to the drawings wherein like numerals refer to like parts throughout. Certain preferred embodiments of the present invention provide a novel formulation for forming a cement composite building article with improved flexural or tensile strength. In one embodiment, the formulation generally includes a hydraulic binder, an aggregate, a low-density additive, fibers, water, and a hydrophobic additive that preferably can be heat activated. In another embodiment, the formulation further comprises a viscosity enhancing agent, pigments, and mineral fillers. In some embodiments, cement mixtures formed in accordance with the preferred formulations are made into a formable paste, shaped into a building article, and then cured at elevated temperature and humidity. Preferably, the article is cured in a manner such that the cement therein is partially hydrated and hardened a density less than about 1.6 g/cm³ and more preferably less than about 1.2 g/cm³. Also preferably the hardened material should have a modulus of rupture (MoR) to modulus of elasticity (MoE) ratio of at least about 1.2 (MPa/GPa). This ratio is also a measure of strain and ductility. The inventors have surprisingly found that medium to low density fiber cement articles formed with a MoR/MoE ratio of at least about 1.2 MPa/GPa are able to achieve the desired properties of nailability and walkability when used as roofing tiles. Moreover, these materials are able to maintain walkability in service, as the product ages.

The various components of the formulation for forming a cement composite roofing article of a preferred embodiment are described in greater detail below.

Hydraulic Binder

The hydraulic binder can comprise Portland cement, high alumina cement, lime, ground granulated blast furnace slag, cement and gypsum plasters or mixtures thereof. In one embodiment, the formulation for the cement composite article comprises about 15% to 50%, more preferably about 25% to 45%, of Portland cement (type I, II or III) by weight on a dry basis. The inventors proceeded against conventional wisdom to incorporate a lower hydraulic binder content in the formulation as fiber cement formulations for roofing articles typically have a high cement content, most typically between about 50%-80% by weight. Advantageously, the inventors have found that the preferred range of hydraulic binder content combines synergistically with the other components of the formulation to yield a much tougher composite material that is more easily nailed and thus more useful in roofing applications.

Aggregates

The aggregates can comprise a siliceous material such as diatomaceous earth, ground silica, rice hull ash, blast furnace slag, and fly ash. In one embodiment, the aggregate has a high surface area and is selected to react with a hydraulically settable binder, such as Portland cement, to form a durable matrix suitable for the intended application of the composite article. For certain roofing article applications, the formulation comprises about 15%-50%, preferably about 25%-45%, ground silica, preferably 200-mesh, on a dry basis. Other suitable aggregates may include, but are not limited to, amorphous silica, granulated slag, steel slag, mineral oxides, sand, coal combustion byproducts, limestone, clays, magnasite or dolomite, metal oxides and hydroxides, or mixtures thereof. The aggregates can be selected based on their compatibility with the other components of the formulation and/or according to their effect on overall composite strength, toughness, and density.

Low Density Additives

The low density additives (LDA) in certain embodiments can comprise hollow ceramic or glass microspheres, diatomaceous earth, synthetic calcium silicate hydrates, and coal combustion residues, such as bottom ash or combinations thereof. In a preferred embodiment, the formulation comprises about 1%-50% of LDA by weight on a dry basis, preferably less than about 20%, more preferably about 2.5%-10%. In one embodiment, the LDA comprises a bottom ash with a particle size of less than about ⅛ inch (3 mm), and more preferably less than about 1/16 inch (1.5 mm). In another embodiment, the LDA comprises a light-weight fly ash with a particle density of less than about 2.3 g/cm³, and a average particle size of about 100 microns. In another embodiment, the LDA can be treated with a hydrophobic material such as silane, wax, stearate or other hydrophobe prior to their incorporation into the mixture. One of the purposes of the LDA is to reduce the overall weight of the composite material and improve its nailability. The LDA can be added individually or in combination with other components. In one embodiment, the LDA is selected for its compatibility with the hydraulic binder and/or aggregates and to optimize cost while reducing its adverse effect on the overall composite strength and water absorption.

Fibers

The fibers can comprise a combination of short and long fibers. The inventors have found that a combination of these two types of fibers give the resulting composite material a unique combination of characteristics typically not found in the material of the prior art. The combination of characteristics includes nailability, crack resistance and toughness.

Short Fibers

The short fibers are, in one embodiment have a length of less than about 3 mm. The short fibers are preferably chosen for their weight reduction properties and effect on nailability and toughness. In certain applications, hollow, low-density fibers such as polymeric or cellulose fibers are preferred. In one preferred embodiment, the short fibers comprise bleached or unbleached Kraft fibers with a length of about 2 to 3 mm and a diameter of less than about 40 microns. To further reduce the fibers' effect on water uptake and durability, the fibers may also be treated with a hydrophobic material, such as silane silanol, waxes stearates or other hydrophobic material.

Optionally the cellulose fibers may be treated with a biocide material that is compatible with cementitious materials and will maintain its biocidal activity for a predetermined amount of time during the service life of any cementitious article made therewith. The biocide should be selected to be effective in the retarding the growth of fungi, bacteria, algae or lichen on or near the surface of the fiber or the adjacent cementitious matrix.

Examples of such biocides are described in PCT publication WO 0232830A1, incorporated herein it its entirety as a reference.

Long Fibers

The long fibers are, in one embodiment, relatively thin and flexible fibers having length of greater than about 9 mm. The long fibers are preferably chosen for enhancement of composite toughness. Fibers that are useful for increasing toughness include, but are not limited to, polymeric fibers or glass fibers, preferably those that are compatible with the applicable binder/aggregate system and curing methods. Such fibers can include, but are not limited to, polyolefins, polyamides, polyester, polypropylene, polymethylpentene, polyacrylonitrile, polyacrylamide, viscose, nylon, PVC, PVA, rayon, carbon, glass or any mixtures thereof. The polymeric or glass fibers may also be hollow. The long fibers are in one embodiment preferably less between about 10-20 mm in length, more preferably about 9-15 mm in length. In certain roofing applications, the long fibers comprise polypropylene fibers of about 20 mm in length and about 5 denier (5 denier signifies that about 900 meters of the fiber weighs about 5 grams). Alternatively, the fibers may be of substantially the same length or width as the finished article and pultruded with the article. In some embodiments, a hydrophilic surface treatment may be applied to the fibers to improve handling and wetting. The fibers may also be treated with antioxidant and UV resistant enhancing materials. Glass fibers suitable for use include alkali resistant glass fibers, E-glass fibers, glass fibers with polymeric coatings and glass fibers with coupling agents compatible with alkaline, cementitious materials. The above polymeric or glass fibers may also incorporate a biocide material, either as a surface treatment to the fiber or as an integral part of the fiber, yet still effective in the retarding the growth of fungi, bacteria, algae or lichen on or near the surface of the fiber or the adjacent cementitious matrix.

Reinforcement Layer

In some embodiments, a reinforcement layer comprising a fiber mesh, fabric, or a polymeric, metal film can also be incorporated into or placed upon the cement composite article in a manner similar to that disclosed in published U.S. application number 20030054123 and incorporated in its entirety herein by reference. The reinforcement layer can comprise any reinforcement material such as, but not limited to, fiber, polypropylene, nylon, glass, nylon, or metal. In one embodiment, the reinforcement layer is a mesh or fabric that can be woven or non-woven, but preferably has regular polygonal or circular openings. The mesh may comprise hollow fibers. The mesh is preferred to have an elongation of no more than 20% at breaking. The mesh should also have high alkaline resistance, high UV resistance, long term durability, be fire resistant, and have a predetermined tensile strength. The reinforcement layer should also have high alkaline resistance, high UV resistance, long term durability, be fire resistant, and have a predetermined tensile strength. There are many polymeric, metal, glass meshes or other materials available that can be selected to meet these criteria. By way of example only, glass or polymeric meshes that have about 4 mm to about 6 mm openings, with a basis weight of about 50 to 180 g/m² and a tensile strength of about 350 to 2000 N per 12 strands have been successfully used. The reinforcement layer, such as a mesh, can be applied to a roofing article while it is in the green state by embedding the layer into the article or by adhering it to the surface with a suitable adhesive, for example polyurethane adhesives, hot-melt polyurethane adhesives, Gorrilla Glue ® or similar may be used. The reinforcement layer may also be pultruded with the cementitious paste in forming the article. Alternatively, the reinforcement layer may be embedded in a cementitious layer that is coextruded with the bulk of the roofing article. The reinforcement layer may also be applied to the surface of a hardened roofing article with a suitable adhesive.

Some examples of mesh material suitable for use as the reinforcement layer are shown below in Table 1.

| | | | | | | Mesh |
|---|---|---|---|---|---|---|
| | | | | | | tensile |
| | | | | | | strength |
| | | | | | Mesh | (Newtons |
| | Manufacturer/ | | | | weight/area | per 12 |
| Mesh | Product | Mesh material | Mesh size | | lbs/1000 ft2 | strands) |
| A | Jiebang Fiberglass Co | AR glass | 4 × 4 | mm | 180 | 1820 |
| | Ltd AR 4 × 4 - 100 L | | | | | |
| B | Jiangsu Jiuding | Coated E glass | 4 × 4 | mm | 80 | 650 |
| | CAG80 6-5 | | | | | |
| C | Conwed Plastics | Extruded | 6.35 × 6.35 | mm | 58 | 355 |
| | R07822 | Polypropylene | | | | |
| D | | Nylon | 6.35 × 6.35 | mm | | |

As will be described in greater detail below, in some embodiments of the invention, a reinforcement layer can be used to hingedly connect two roofing articles along adjacent edges in such a way that the article may be flexibly placed along the ridgeline of a roof or along the hip area of a roof.

Hydrophobe

The hydrophobe can reduce the water absorption of the composite material by a number of different methods, such as by limiting the uptake of liquid water and/or taking part in controlling the rate of hydration of the cement binder. In one embodiment, the hydrophobe is selected based on its efficiency, effect on binder hydration, and dispersability. The hydrophobes that can be used include, but are not limited to, salts of fatty acids, preferably stearates, more preferably zinc stearate. Other examples of hydrophobic material that may be used include, but are not limited to, silicones such as silanes, siloxanes, and siliconates, paraffin waxes, paraffin wax emulsions, asphaltic, or the like. In certain roofing applications, the hydrophobe is added to reduce the water absorption of the composite to below about 10% by weight, even after about 24 hours of submersion in water. The above hydrophobic materials may be integrally combined with the cementitious matrix. The hydrophobic materials may also be applied to hydrophilic fibers added to the matrix, such as cellulose fibers. hydrophobic materials in the form of emulsions, suspensions or powders may also be applied to one or more surfaces of an article formed using the inventive formulations described herein.

Viscosity Enhancing Agent

The viscosity enhancing agent (VEA) is herein defined as a material that affects the workability and moldability of an uncured cementitious composition by reversibly binding with and affecting the availability of free water in the uncured composition and retarding cement hydration. Examples of VEAs include cellulose ethers, clays, and other synthetic organic water soluble polymers. In one embodiment, cellulose ethers are generally preferred and any of the following types of cellulose ether may be used individually or in combination: methylhydroxyethylcellulose, hydroxymethylethylcellulose, hydroxyethylproplylcellulose, hydroxypropylmethycellulose, and hydroxyethylcellulose. Moreover, other types cellulose ethers that have the same or similar properties would also work well. In certain roofing applications, the VEA preferably comprises hydroxyethlmethycellulose. Suitable VEAs may include all manufacture grades of cellulose ethers manufactured by Dow Chemical, Shin Etsu Chemical and Wolff Walsrode. In practice, the unique synergy between the VEA and the hydrophobe can be exploited to achieve both a desired degree of water repellency and a predetermined rate of hydration during the curing of the product and through the product's life cycle as it is exposed to the elements.

Fillers

Mineral fillers may be incorporated in the formulation to provide specific desired effects such as particle packing, nailability, improved toughness, or reduced cost. Carbonates, borates or metal oxides may make suitable fillers In certain roofing applications, calcium carbonate of a nominal particle size of about 20 microns or less is preferred.

Pigment

Pigments may be used to color the cement composite article in some applications. The pigments preferably are selected to have long term color stability and compatibility with the chosen binder. In certain roofing applications, alkaline-stable inorganic pigments are chosen to be used in conjunction with a Portland cement based binder. Preferably, certain pigments are also selected to aid in the retardation of cement and control cement hydration. In certain embodiments, the preferred pigments comprise transition metal oxides, such as iron oxide, chromium oxide, etc. Powdered carbon such as carbon black may also be used. In some embodiments, pigments can be added dry or as an aqueous suspension. In certain preferred roofing applications, the pigment comprises a blend of about 0.35% red iron oxide and about 1% carbon black or black iron oxide.

Water

In some embodiments, the water required in the formulation for the mixture to provide appropriate density and green properties is in the range of about 26% to 32%, an example being about 30%. The percentage of water can be calculated as [mass of water/(mass of water+mass of dry ingredients)]×100. When batching water is calculated, it may be necessary to measure and then substract the water that may be present in any of the solid ingredients.

Table 1 provides the formulation ranges of the cement composite article of certain preferred embodiments of the present invention.

TABLE 1
Formulation ranges for the cement composite article of certain preferred
embodiments of the present invention

| | Ingredient Name | | Example #1 (% by wt) | Example #2 (% by wt) | Example 3 (% by wt) |
|---|---|---|---|---|---|
| 1 | Hydraulic binder | | about 15%-50% | about 25%-45% | about 40% |
| 2 | Aggregate | | about 15%-50% | about 25%-45% | about 40% |
| 3 | Low Density Additive | | about 0-20% | about 2.5-10% | about 5% |
| 4 | Fiber | Short | about 1%-15% | about 1%-11% | about 6% |
| | | Long | about 0.1%-3% | about 0.1-1% | about 0.4% |

| 5 | Hydrophobe | about 0%-2% | about 0%-1% | about 0.75% |
|---|---|---|---|---|
| 6 | Viscosity Enhancing Agent | about 0.4% 2.5% | about 0.5%-2% | about 0.8% |
| Optional Ingredients | | | | |
| 7 | Filler | about 0%-20% | about 0%-10% | about 5% |
| 8 | Pigment | about 0%-5% | about 0%-3% | about 1.35% |

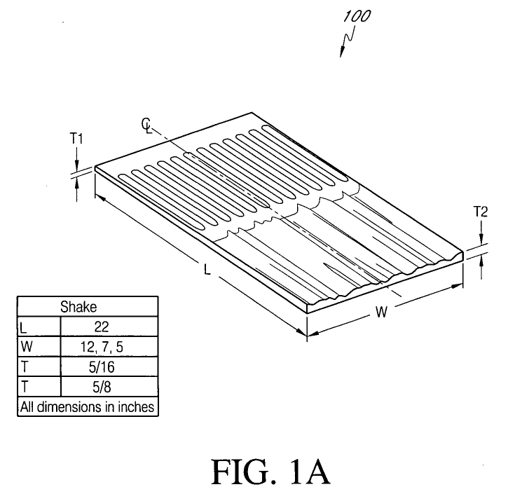

FIG. 1A is a schematic illustration of a cement composite roofing article 100 formed in accordance with a formulation of one preferred embodiment of the present invention. As shown in FIG. 1A, the roofing article 100 has the appearance of a conventional wood shake and preferably has a length of about 22 inches, a width of about 12, 7, or 5 inches, a thickness ranging between 5/16 to ⅝ inch. In one embodiment, the roofing article 100 preferably has a length to width aspect ratio of about 35 to 1.

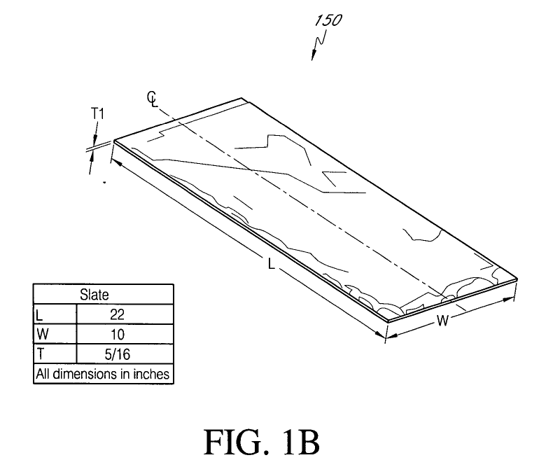

FIG. 2B is a schematic illustration of another cement composite roofing article 150 formed in accordance with a formulation of another preferred embodiment of the present invention. As shown in FIG. 1B, the roofing article 150 has the appearance of a conventional slate roof tile and has a length of about 22 inches, a width of about 10 inches, and a thickness of about 5/16 inch. Preferably, the roofing article 150 has a length to width aspect ratio of about 70 to 1. It will also be appreciated that the fiber cement roofing articles of the preferred embodiments can be of varied size, for example having an average aspect ratio of less than about 160, in one embodiment less than about 50.

The roofing articles 100 and 150 formed in accordance to the formulations described above are lightweight, nailable, crack resistant with a high ultimate strain and low water absorption. When the roofing articles are subject to cyclic freeze/thaw and/or cyclic wet/dry/carbonation cycles, the roofing articles preferably demonstrate substantially the same or increased bending strength and z-direction tensile strength.

FIG. 2 is a schematic illustration of a method 200 of manufacturing a roofing article formed in accordance to a fiber cement formulation of the preferred embodiments of the present invention. The method comprises the following steps.

Step 210: Forming Homogeneous Paste

In Step 210, raw materials are measured into a mixer, blender, or compounder, or the like such as an Eirich® mixer or Hobart® mixer, at concentration levels in accordance with any of the embodiments described in Table 1. These materials are combined with water such that the water to solids ratio is about 35% to 45%, more preferably about 40% to 43%. The components are mixed into a substantially homogeneous paste.

Step 220: Forming Article

In Step 220, the substantially homogeneous paste is extruded, molded or pressed into a die, mold or any form of a molding apparatus, or roll press to form a the roofing article with a desired profile. If extrusion or roll pressing is used, a ribbon with the cross section profile of the final roofing article may be formed and subsequently cut into smaller pieces. Alternatively, the ribbon may be cut into pieces of intermediate length while the paste is in the unhardened “green” state and subsequently cut to the final dimensions after the article is hardened according to the method described herein. While the ribbon or the pieces of intermediate length remain in a non-self supporting “green” state, they are preferably supported by a rigid plate or mesh or bottom mold as they proceed through the embossing, hardening and coating steps herein.

Step 230: Embossing of Article/Integration of Mesh

In Step 230, at least one decorative pattern is optionally imparted into one or both sides of the article, by means such as embossing rolls, embossing plates or any other texturing apparatus known in the art. In a preferred embodiment, a fabric or mesh is applied to the underside of the article while the article is being embossed, such that the mesh or fabric is embedded into the underside of the article.

Step 240: Hardening of Article

In Step 240, the article is achieves a hardened, self supporting state by curing it in an environment of predetermined temperature and humidity for a preselected time. A result of this type of hardening is that the cement binder is only partially hydrated. Curing can be done by any means such as electrically heated chamber or oven, a steam-heated chamber or oven, a forced-air heated chamber or oven. Preferably said oven or chamber includes a means of humidification such as steam injection, water spray, ultrasonic misters, or the like. Curing or hardening may be accomplished in batches or by passing material continuously through an oven or chamber. Said oven or chamber may also be subdivided in to zones, each zone having a predetermined temperature and humidity, preferably in the range of 35° C.˜90° C. and relative humidity of 10˜60%.

Hardening of the article may be accomplished under almost any range of temperature and humidity conditions suitable for achieving a predetermined degree of cure, density and bending strength in the article. Preferably, the article is hardened such that it has an MOR/MOE ratio of at least about 1.2 (MPa/GPa). Steam chests, wet curing tanks, strength, humidified chambers, or ovens may be used alone or in combination to achieve the temperature and humidity conditions required to achieve this MOR/MOE ratio. For the formulation described in Example 1, the article was hardened by exposing it for approximately 3.5 hours at about 140° F. and about 40% RH then about 6.5 hours at about 113° F. and about 20% RH using a climate chamber. For the formulation described in example 2, the sample was hardened by passing it through a gas-fired oven with multiple zones, each zone having a selected temperature, humidity and dwell time within each zone, until an MoR/MoE ratio>1.2 was obtained.

The inventors have discovered that the partial curing of the formed article, combined with the specifically selected hydration managing effects of the VEA and the hydrophobe impart certain advantageous characteristics to the building article. By careful manipulation of these elements, the inventors surprisingly found that articles formed from the formulations of the preferred embodiments of the present invention and according to the method of the preferred embodiments of the present invention can achieve the nailability, walkability, toughness and strength targets in spite of having a low density with reduced thickness. Articles so formed were also found to maintain or even improve their key properties during accelerated aging tests.

Step 250: Coating of Article

In Step 250, the cured sheets are water-jet cut into individual articles of various sizes. If coating is desired the articles are then spray-sealed, on all sides with an acrylic latex sealer. The sealer may be cured using a continuous infra-red (IR) drying oven to yield a board surface temperature sufficient to dry and cure sealer. The board surface temperature selected will depend upon the specific sealer formulation, however board surface temperatures between 200 and 375 are typical. The coating may be selected to enhance the appearance of the articles, for example by providing a specific color or gloss. The coating may also be selected to reduce or inhibit efflorescence.

Step 260: Packing of Article

In Step 260, the article is stacked and then packaged for shipping. In one embodiment, the shakes are preferably stacked face to face and back to back in alternating layers and bound with packing straps to make a bundle weighing approximately 30 pounds.

### EXAMPLE 1

In this example, roofing articles were formed using the above method 200 from a paste compounded according to the formulation shown below.

| | | |
|---|---|---|
| about 30.9% | Binder | (Type II Portland Cement) |
| about 30.9% | Aggregate | (200 mesh ground silica) |
| about 0.4% | Long fiber | (5 denier × 15 mm polypropylene fiber) |
| about 5% | Short fiber | (Bleached pulp) |
| about 25% | Low Density | (Bottom ash, screened to <3 mm) |
| | Additive | |
| about 0.75% | Hydrophobe | (Zinc Stearate) |
| about 0.8% | VEA | (Walocel ® Hydroxyethylmethylcellulose) |
| about 0.35% | Red pigment | (Red iron oxide) |
| about 1% | Black pigment | (Carbon Black) |
| about 5% | Filler | (Calcium carbonate - 20 micron) |

The article was hardened by exposing it for approximately 3.5 hours at about 140° F. and about 40% RH, and then for about 6.5 hours at about 113° F. and about 20% RH using a standard commercially available, electronically controlled climate chamber.

### EXAMPLE 2

In this example, roofing articles were formed using the above method 200 from a paste compounded according to the formulation shown below:

| | | |
|---|---|---|
| about 40.35% | Binder | (Type II Portland Cement) |
| about 40.35% | Aggregate | (200 mesh ground silica) |
| about 0.4% | Long fiber | (5 denier × 15 mm polypropylene |
| | | fiber) |
| about 5% | Short fiber | (Bleached pulp) |
| about 5% | Low Density | (lightweight fly ash) |
| | Additive | |
| about 0.75% | Hydrophobe | (Zinc Stearate) |
| about 0.8% | VEA | (Hydroxyethylmethylcellulose) |
| about 0.35% | Red pigment | (Red iron oxide) |
| about 1% | Black pigment | (Carbon Black) |
| about 5% | Filler | (Calcium carbonate - 20 micron) |

TABLE 2
Mechanical Properties

| Property (units) | Example 1 | Example 2 |
|---|---|---|
| Modulus of Rupture | 3.8 | 4.2 |
| MoR (MPa) | | |
| Modulus of Elasticity | 2.5 | 1.8 |
| MoE - (GPa) | | |
| MoR/MoE ratio | 1.52 | 2.33 |
| Oven Dry Density | 1.175 | 1.15 |
| Z direction tensile - | 0.75 | 0.75 |
| ZDT (MPa) | | |
| ZDT after 80 freeze | 1.48 | 1.48 |
| thaw cycles (MPa) | | |
| % ZDT retention | 197% | 197 |

Table 2 summarizes the mechanical properties of one embodiment of the roofing article formed with the formulation shown in Example 1.

The moduli of Rupture and Elasticity were determined on oven dried samples using a four point bend test according to ASTM D6272. The Freeze/thaw cycling test method used involves placing samples (44 mm×44 mm) on the edge in a shallow plastic container such that the bottom about 22 mm is submerged. The samples are then placed in an environmental chamber and cycled according to the following program (note that the following temperatures denote sample temperature, not chamber temperature):
hold about 20° C. for about 1 minute;
ramp down from about +20° C. to −20°±1° C. in not less than about 1 hour and not greater than about 2 hours;
hold at about −20° C.±1° C. for about 1 hour;
ramp up from about −20° C. to +20° C.±1° C. in not less than about 1 hour and not greater than about 2 hours;
hold about +20° C.±1° C. for about 59 minutes

After 80 cycles, the samples are removed and weighed, then oven dried in an about 105° C. forced air oven for about 24 hours weighed and placed in a desiccator to cool. Z-direction tensile strength of the samples is determined by gluing tensile test jigs to each face of the sample. The samples are equilibrated for about 18 hours@about 23° C. and 50% relative humidity prior to testing, then placed into a suitable mechanical test apparatus (e.g. Instron test rig) and loaded axially along the Z axis until failure.

Samples of one embodiment of the invention were formulated to demonstrate no significant loss in z-direction strength and were surprisingly found to have substantial increase in strength by about 197% after about 80 freeze thaw cycles.

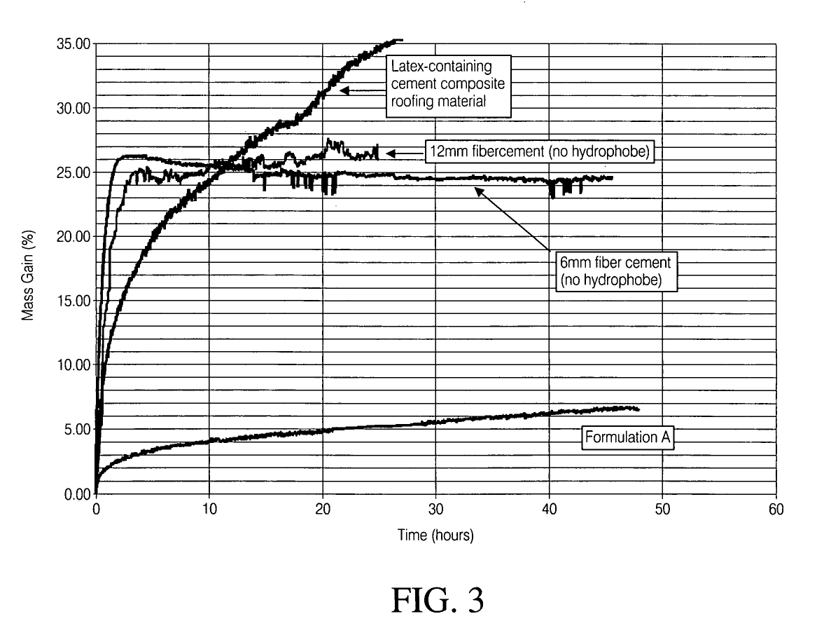

FIG. 4 shows the performance of this material versus high-density fiber cement slates known in the prior art as well as a commercially available medium density fiber cement shake utilizing polymer latex as a waterproofing agent.

Water Absorption

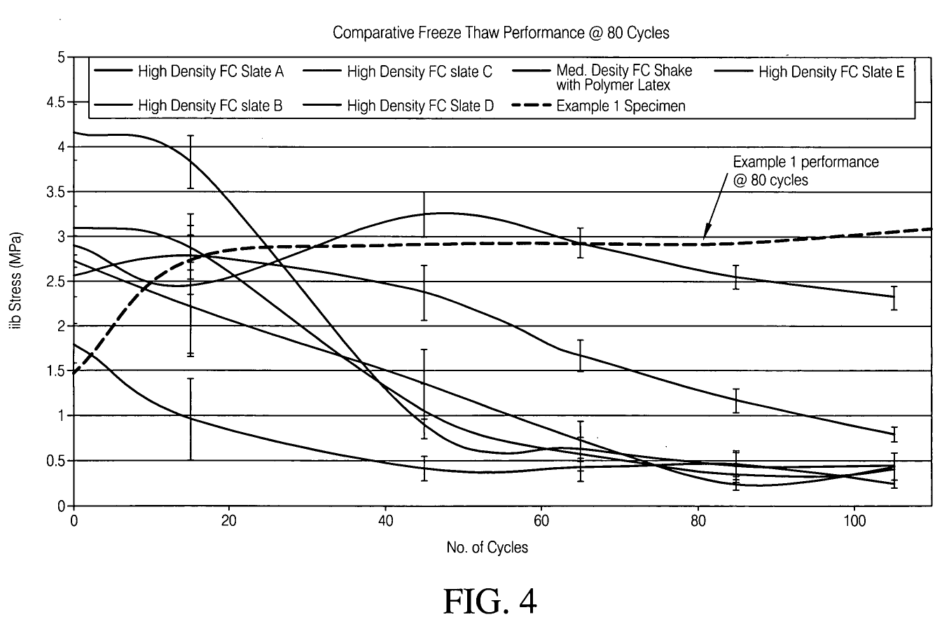

FIG. 5 illustrates the mass gain over time after submerging samples of various fiber cement composites in water. Formulation A is made according to one embodiment of the present invention. Note that while cement composites treated with polymer latex offer short term water repellency, after 10 hours the weight gain is similar to fiber cement composites treated with no hydrophobe at all.

Wind Uplift Test

Articles made according to the preferred formulations and methods of the present invention were evaluated using the Wind uplift test of ICBO AC07. Acceptance Criteria for Special Roofing Systems—Section 4.3. Exemplary results are shown below in Table 3. As shown in Table 3, articles made using embedded meshes were able to withstand the highest exerted pressure (in inches of water) and are preferred, although adhered meshes also show improvement over those articles having no mash or fabric reinforcement.

TABLE 3

| | | | Wind Uplift |
|---|---|---|---|
| | | | Performance |
| | | Mesh | (inches of |
| Mesh | Mesh material | placement | water) |
| A | AR glass | embedded | 22 |
| B | Coated E glass | embedded | 15 |
| C | Extruded | embedded | 9 |
| | Polypropylene | | |
| D | Nylon | adhered to | 8.25 |
| | | surface | |
| Control | None | None | 7 |

FIG. 5 illustrates the back surface 501 of a roof covering article 500 such as those depicted in FIGS. 1A and 1B. As shown FIG. 5, a reinforcement layer 502 is incorporated into the back surface 501 of the roofing article 501 by preferably embedding the reinforcement layer into the article while the article is still in a green paste-like state. Alternatively, the reinforcement layer 502 may also be adhered to the back surface of the roofing article 500 using any suitable adhesives or fastening means, preferably when the back surface of the roofing article 500 is in a green state or in a hardened, self supporting state. The reinforcement layer 502 can include a variety of different materials including, but not limited to, meshes, fabrics, or film.

In certain embodiments, the reinforcement layer is preferably positioned in regions on the roofing article 500 where fastening devices, such as nails, are driven through the article. As shown in FIG. 5, the reinforcement layer 502 comprises a mesh positioned over the two fastening locations 503A and 503B of the roofing article 500. The mesh advantageously reinforces the roofing article 500 in locations where the fasteners are driven through the article and helps keep the article in tact should cracks occur from excessive loads results from stress. The mesh also reinforces the article from stress resulting from wind, foot traffic, hail and the like.

In one preferred embodiment, the roofing article 500 is about 22 inches in length and the reinforcement layer 502 extends along the backside of the roofing article 500 a distance of approximately 2 inches above the fastening locations 503 A and 503 B and about 8 to 10 inches below the fastening locations 503 A and 503 B. In another preferred embodiment, the roofing article 500 is about 22 inches in length and the reinforcement layer 502 extends along the backside of the roofing article 500 a distance of approximately 2 inches above the fastening locations 503 A and 503 B and extends to the edge to roofing article 500 below fastening locations 503 A and 503 B. In this way the roofing article 500 is resists crack propogation when it is fastened to the roof deck and resists cracking from foot traffic, hail and the like on the weather-exposed areas of the roofing article. Roofing articles of this embodiment are also well reinforced and resist cracking in wind uplift tests.

While FIG. 5 shows a rectangular roofing article 501, it can be appreciated that the roofing article of the preferred embodiments can be of any shape or profile and that more than one reinforcement layer may be used in multiple locations on the roofing article 500 and may or may not overlap with each other. The reinforcement layers may also be located on the surface or different surfaces of the roofing article.

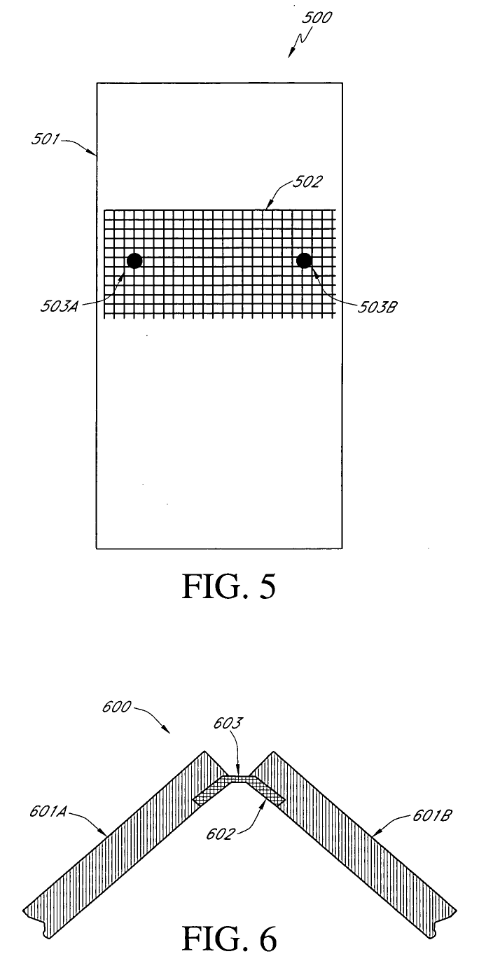

FIG. 6 illustrates a cross section view of a roofing article assembly 600 of another embodiment configured to cover the hip or ridge area of the roof. As shown in FIG. 6, the roofing article assembly 600 generally comprises at least two separate pieces of roofing article 601A, 601B comprised of roofing shakes, slates, or the like. The two roofing articles 601A, 601B are hingedly interconnected by a joint 602. The joint 602 preferably comprises a reinforcement layer such as a mesh, fabric, or film. Preferably, the reinforcement mesh is attached to or embedded in the back surface of the roofing article in a manner described above. The joint can extend continuously or discontinuously along the edges of the roofing shakes or slates. In one embodiment, the region of reinforcement may be treated or impregnated with a UV resistant and/or water resistant coating or layer, such as a silicone, silane acrylic, or urethane based coating.

Certain preferred embodiments of the present invention provide a cementitious formulation comprising a binder, an aggregate, a low density additive, long fibers, short fibers, a hydrophobe, and a viscosity enhancing agent. In one embodiment, the hydrophobe and the viscosity enhancing agent are selected to control the rate of hydration of the binder. The preferred cementitious composition can be used to produce a lightweight, durable, and nailable roofing article, such as a roofing tile. In another preferred embodiment, the cementitious composition is extruded into an article of predetermined length and wedge shaped cross section for use as a starter strip or cant strip installed underneath the bottom row of roofing articles on a roof. In one embodiment, the roofing article comprises a lightweight cementitious composition with a density of less than about 1.2 g/cc. In one embodiment, the composition of the roofing article is configured to maintain or increase its z-direction tensile strength after 80 freeze/thaw cycles. In one embodiment, the roofing article has an MOR/MOE ratio of greater than about 1.2 MPa/GPa. In another embodiment the roofing article incorporates a reinforcing mesh or fabric on the back surface of the article in the region surrounding the area where fasteners are inserted through the article into a supporting frame.

There are many advantages afforded by the preferred embodiments of the present invention. The preferred embodiments provide a fiber cement composite formulation that can be formed into nailable, durable and lightweight building articles having exceptional freeze/thaw stability via a combination of hydrophobic materials and viscosity enhancing agents Moreover, the preferred embodiments provides a fiber cement roofing article with a density of less than about 1.6 gm/cc that may be nailed without cracking and whose z-direction tensile will not substantially decrease even after 80 freeze/thaw cycles. The preferred embodiments also provide a method of forming a nailable and durable roofing tile. Moreover, the resulting composite material looks, handles, and installs like a wood article. The resulting composite material can be made without the use of costly additives such as accelerants, polymer latexes, or silica fume to enhance the properties of the cement composite. When some preferred embodiments are incorporated into a hip or ridge covering for a roof, said coverings are durable, walkable, nailable and can also be placed on roofs of any pitch or design.

Although the preferred embodiments of the present invention has shown, described and pointed out the fundamental novel features of the invention as applied to these embodiments, it will be understood that various omissions, substitutions and changes in the form of the detail of the formulations, articles, and methods illustrated may be made by those skilled in the art without departing from the scope of the present invention. Consequently, the scope of the invention should not be limited to the foregoing descriptions.

1. A formulation for manufacturing a cement composite roofing article, comprising:
a hydraulic binder;
aggregate;
a low density additive;
fibers;
a hydrophobe;
wherein the components are selected to produce a cement composite roofing article having a Modulus of Rupture (MoR) to Modulus of Elasticity (MoE) ratio of about 1.2 MPa/GPa or greater, a density of about 1.6 g/cm³ or less, and said roofing article is nailable and substantially resistant to stress induced cracking.

2. The formulation of claim 1, further comprising a viscosity enhancing agent.

3. The formulation of claim 1, further comprising fillers and pigments.

4. The formulation of claim 1, wherein the fibers comprises long and short fibers.

5. The formulation of claim 1, wherein the fibers are selected from the group consisting of cellulose fibers, polypropylene fibers, polyester fibers, polyolefin fibers, nylon fibers, and combinations thereof.

6. The formulation of claim 1, wherein the hydrophobe is selected from the group consisting of stearates, silicones, paraffin waxes, asphaltic, and combinations thereof.

7. A cement composite roofing article having a MoR/MoE ratio of about 1.2 MPa/GPa or greater, a density of about 1.6 g/cm³ or less, and is nailable without developing stress induced cracking.

8. The roofing article of claim 7, wherein said roofing article is a roofing tile.

9. The roofing article of claim 8, wherein said roofing tile is configured to resemble a wood shake tile.

10. The roofing article of claim 8, wherein said roofing tile is configured to resemble a slate tile.

11. The roofing article of claim 8, wherein said roofing tile has a thickness ranging between about 5/16 to ⅝ inch and an aspect ratio of about 35 to 1.

12. The roofing article of claim 8 further including at least one reinforcement layer positioned in an area on the roofing article that is exposed to stress.

13. The roofing article of claim 12, wherein said reinforcement layer is selected from the group consisting of a fiber mesh, fabric, film, and combinations thereof.

14. The roofing article of claim 12, wherein said reinforcement layer is positioned in an area on the roofing article adapted to receive a fastener.

15. The roofing article of claim 12, wherein said reinforcement layer is embedded in said article.

16. The roofing article of claim 12, wherein said reinforcement layer is attached to a lower surface of said article.

17. A cement composite roofing article configured for covering the hip or ridge areas of a roof, comprising:
a first portion comprising a nailable and substantially crack resistant cementitious material;
a second portion comprising a nailable and substantially crack resistant cementitious material;
wherein said first and second portions are hingedly interconnected to each other by a connecting member in a manner such that at least one of the portions is pivotable about a central axis defined by the connecting member.

18. The roofing article of claim 17, wherein the connecting member comprises a flexible reinforcement material.

19. The roofing article of claim 18, wherein said connecting member comprises a fiber mesh.

20. The roofing article of claim 19, wherein said connecting member is attached to a lower surface of each of the two portions.

21. The roofing article of claim 18, wherein the angle between the two portions can be adjusted between about 30 to 180 degrees.

22. A method of forming a cement composite roofing article, comprising:
mixing a hydraulic binder, aggregate, a low density additive, and a hydrophobe to form a cementitious mixture;
forming a green article;
curing the green article by partially hydrating the cement to form a cement composite roofing article, said article is nailable and substantially crack resistant, said article having a MoR/MoE ratio of about 1.2 MPa/GPa or greater and a density of about 1.6 g/cm³ or greater.

23. The method of claim 22, further comprising embossing the article with a design prior to curing the green article.

24. The mixture of claim 22, wherein forming said green article comprising extruding the cementitious mixture.

25. The mixture of claim 22, further comprising forming a reinforcement layer in said roofing article.

26. A method of forming a cement composite roofing article for use in covering the hip or ridge of a roof, comprising:
positioning a nailable and crack resistant cement composite roofing article adjacent to a second cement composite roofing article wherein the side surfaces of the two articles face each other; and
attaching the first cement composite roofing article to the second cement composite article in a manner such that the first roofing article is pivotable about the second article.
